(19) United States
(12) Patent Application Publication
(10) Pub. No.: US 2025/0266783 A1
(43) Pub. Date: Aug. 21, 2025

(54) PULSE WIDTH MODULATION AND PHASE SHIFT CONTROL OF A DUAL INVERTER WITH DUAL PROCESSORS

(71) Applicant: DANA TM4 INC., Boucherville (CA)

(72) Inventors: Jianhong XU, Koekelare (BE); Maalainine EL YACOUBI, Waregem (BE); Charles OBRY, Brugge (BE); Mohammed AMAR, Brugge (BE)

(21) Appl. No.: 19/053,268

(22) Filed: Feb. 13, 2025

Related U.S. Application Data
(60) Provisional application No. 63/554,027, filed on Feb. 15, 2024.

(51) Int. Cl. H02P 27/08

(52) U.S. Cl. CPC H02P 27/08

(57) ABSTRACT

Systems and methods for synchronizing pulse width modification for a dual inverter system are disclosed. For example, a method for synchronizing pulse width modulation (PWM) of a master inverter and a slave inverter may include: receiving a PWM command at a master PWM generator of the master inverter from a master central processing unit (CPU) communicatively coupled to the master PWM generator; generating a synchronization pulse at the master inverter; determining at a slave CPU communicatively coupled to a slave PWM generator of the slave inverter a phase shift error from the synchronization pulse; and adjusting a phase of the slave inverter PWM using the determined phase shift error.

### CROSS REFERENCE TO RELATED APPLICATION

The present application claims priority to U.S. Provisional Application No. 63/554,027 entitled “PULSE WIDTH MODULATION AND PHASE SHIFT CONTROL OF A DUAL INVERTER WITH DUAL PROCESSORS” filed Feb. 15, 2024. The entire content of the above application is hereby incorporated by reference for all purposes.

### TECHNICAL FIELD

The present description relates generally to methods for synchronization of pulse width modulation and phase shift control in a multi inverter with multi processors and a common direct current link capacitor.

### BACKGROUND AND SUMMARY

Voltage inverters use various pulse width modulation (PWM) methods to convert direct current (DC) supply voltage from a power source to alternating current (AC) voltage. For example, it may be demanded that DC be converted to AC in order to be accepted by AC machines (e.g., synchronous machines and induction machines). Voltage inverters supply AC side voltages in voltage pulses, wherein each voltage pulse consists of an on state and an off state. DC current is supplied from the power source when an inverter is in the on state. DC current from the power source is not supplied when the inverter is in the off state. Some DC power sources, such as an electric vehicle (EV) battery, are not suitable for supplying pulse currents and instead provide continuous current. Therefore, a DC link capacitor may be demanded to absorb high frequency harmonic components of pulse currents incurred on the inverter's DC side. Generating the least possible DC side harmonic currents through the voltage inverter's PWM method may be desired to reduce the DC link capacitor size and power dissipation in the capacitor, thereby reducing resource demand and facilitating a cooling circuit design.

Two PWM generators (e.g., inverters or other devices using PWMs) may be desired for supplying current to a dual electric machine (e.g., two electric machines) or a multiphase electric machine. Current synchronization between the two PWM generators may be achieved in some examples by including a slave inverter that generates a slave PWM and a master inverter that generates a master PWM. In such examples, the slave PWM may be reset in response to receiving a synchronization signal. In this way, synchronization may be achieved when both the master PWM and slave PWM function at a same constant nominal switching frequency. Therefore, such a method may be suitable for fixed frequency inverter applications such as inverters in a high-voltage direct current (HVDC) transmission.

However, current synchronization methods, such as the example described above, may not be adequate for PWMs with variable frequency. For example, inverter PWM frequencies in an EV may be controlled to vary according to speed and torque of electric machines of the EV to reduce switching losses or to reduce noise, vibration, and harshness (NVH). Due to the current control loop and current sampling being conducted in synchronization with the PWM period, applying such current synchronization methods, such as resetting the slave PWM counter, to variable PWM frequencies may create discontinuities in the control, resulting in instability. Additionally, current synchronization methods may be able to synchronize inverters with a common central processing unit (CPU), but may not be able to synchronize inverters with separate CPUs. Having separate CPUs may be demanded for a dual inverter system due to processing power capability, for example. Additionally or alternatively, having separate CPUs may be desired to reduce complexity by allowing for conventional architecture (as used for a single CPU with a single inverter) rather than demanding adaptations to a CPU to be compatible in a system including two inverters with a single shared CPU.

Thus, methods for synchronizing pulse width modulation (PWM) of a master inverter and a slave inverter are disclosed herein to address at least some of the issues described above. In one example, a method in accordance with the present disclosure may comprise: receiving a PWM command at a master PWM generator of the master inverter from a master central processing unit (CPU) communicatively coupled to the master PWM generator; generating a synchronization pulse at the master inverter; determining at a slave CPU communicatively coupled to a slave PWM generator of the slave inverter a phase shift error from the synchronization pulse; and adjusting a phase of the slave inverter PWM using the determined phase shift error. In this way, the PWM synchronization method of the present disclosure does not demand a reset of the slave PWM counter when a synchronization pulse occurs. Instead, the slave PWM counter keeps counting as usual and the present slave PWM cycle continues to the end. A phase shift error is determined by the slave PWM counter's present value and the phase shift error is used to synchronize the slave PWM and master PWM. Thus, the PWM synchronization method disclosed herein may not result in discontinuities in the control loop, nor impact current sampling. By synchronizing the slave PWM frequency to the master PWM frequency and by using the same neutral modulation scheme, similar harmonic currents will be produced on the DC side of each inverter if the supplied machines (e.g., electric motors of an EV) operate at similar speeds and produce similar torques. With control of the phase shift of the slave PWM with respect to the master PWM, an increased quantity of harmonic currents can be cancelled, thus minimizing the quantity of harmonic currents flowing into the DC link capacitor.

Reducing current flowing into the DC link capacitor may allow for a reduction in size of the DC link capacitor (e.g., volume, capacitance, and/or mass of material, etc.), thus reducing resource demand. Additionally, by incorporating two inverters into a single system, such as the inverter system disclosed herein, resource demand may be reduced compared to using two separate (e.g., physically and/or electrically separate) inverters. For example, a single DC link capacitor may be coupled to both the slave inverter and master inverter, rather than two DC link capacitors with each coupled to one inverter. Moreover, due to including one housing in the inverter system rather than two housings for two separate inverters, resource demand may be further reduced.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

Various aspects of this disclosure may be better understood upon reading the following detailed description and upon reference to the drawings, in which:

FIG. 1 shows a schematic representation of an exemplary electric or hybrid vehicle.

FIG. 2 shows a schematic representation of an exemplary dual inverter system according to the present disclosure.

FIG. 3 shows a first timeline diagram of events of interest during synchronization of a dual inverter.

FIG. 4 shows a second timeline diagram of events of interest during synchronization of a dual inverter.

FIGS. 5A-5C show graphs of a master ramp, a synchronization pulse, and a slave ramp during example switching cycles.

FIG. 6 shows a flowchart of an example of a method for synchronization of a dual inverter.

FIGS. 7A-7C show example inverter schematics and gate drivers of power stages.

### DETAILED DESCRIPTION

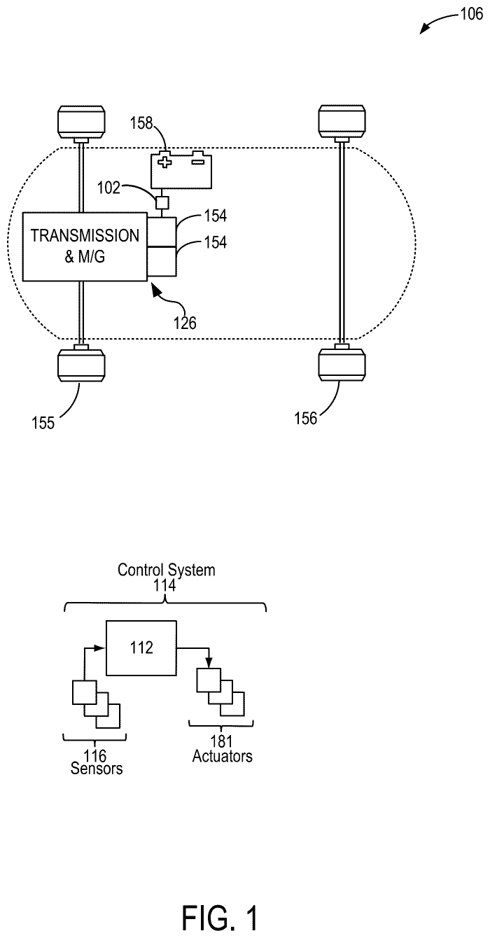

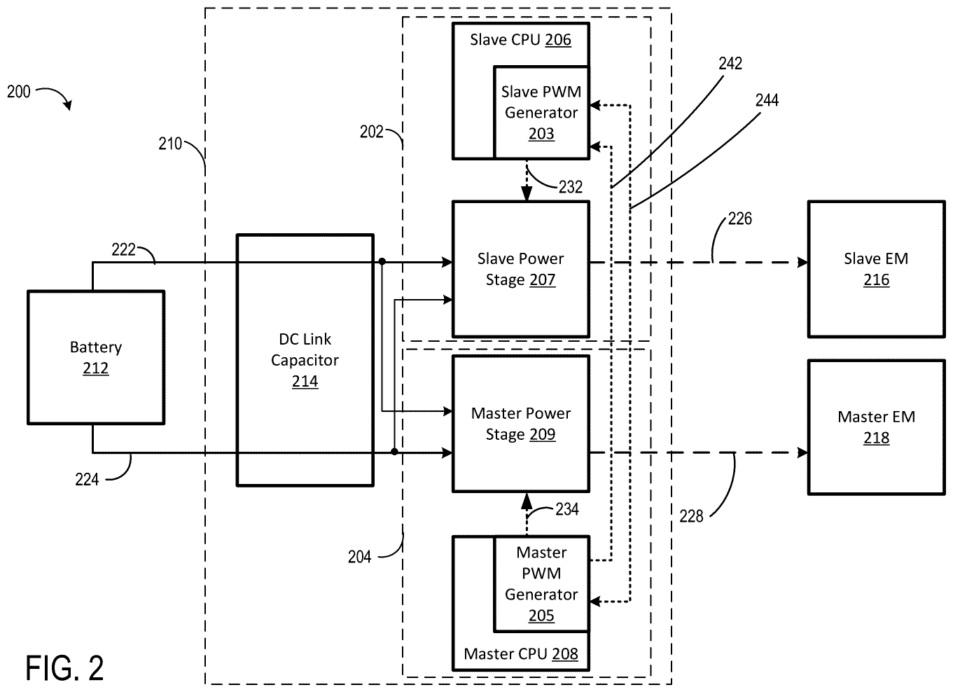

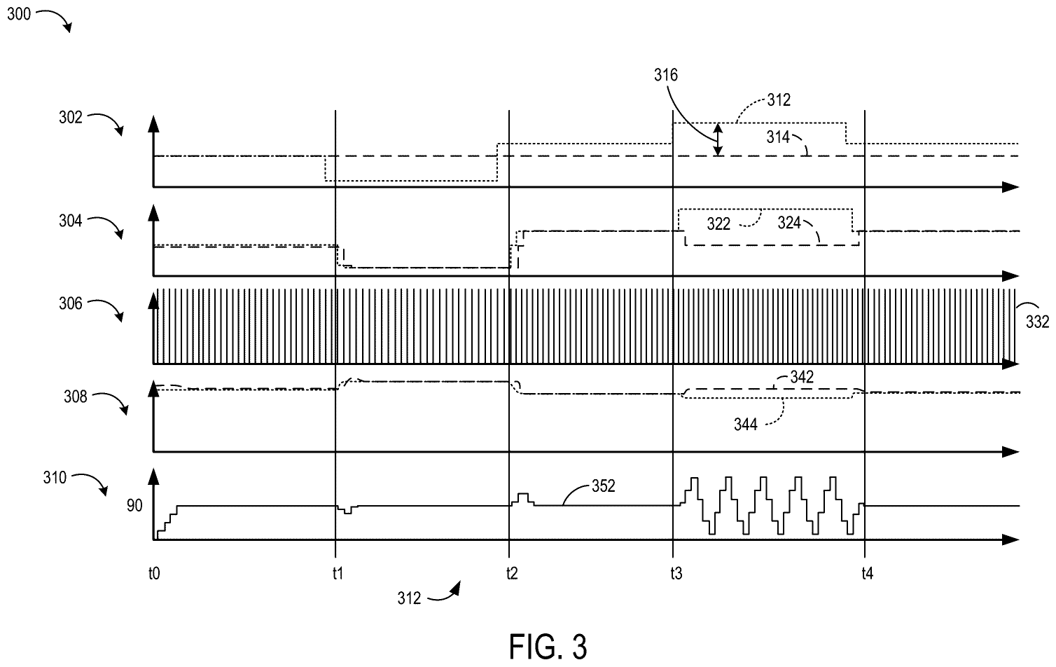

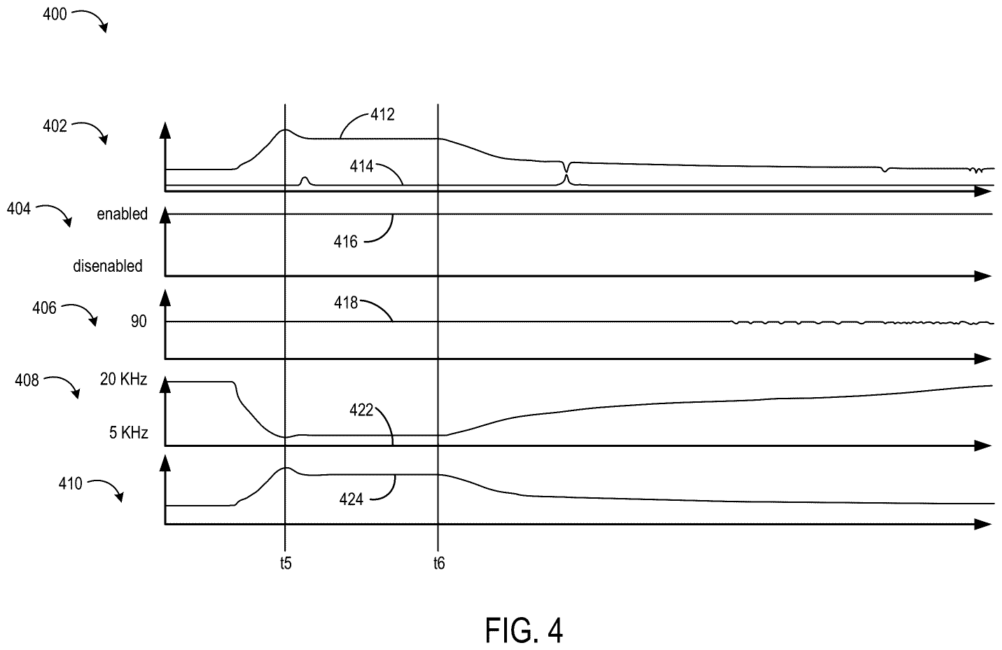

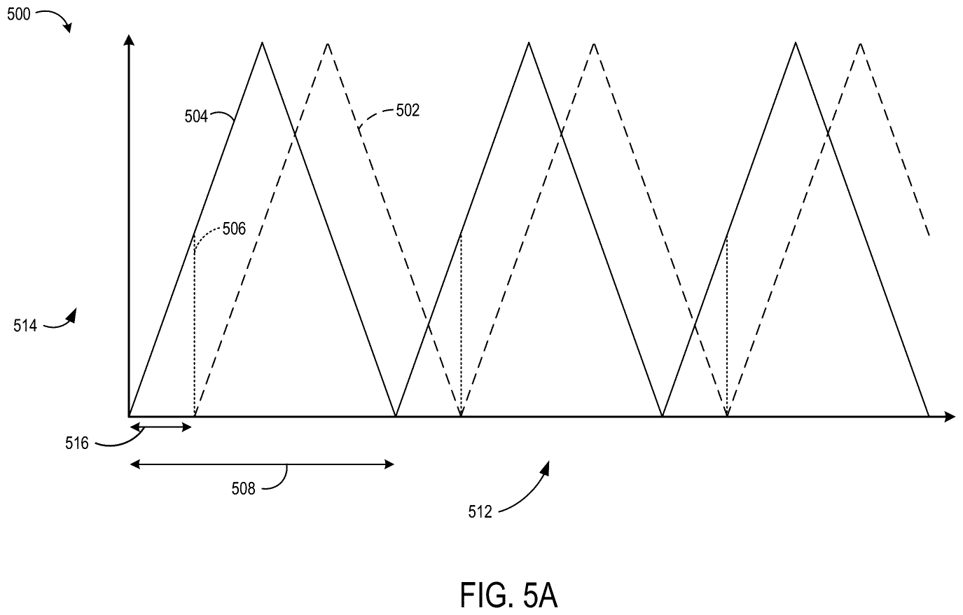

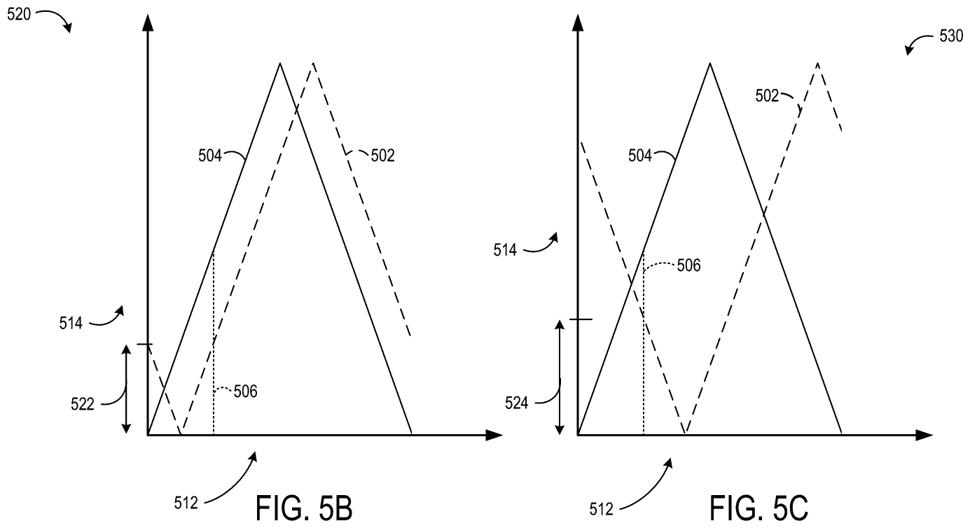

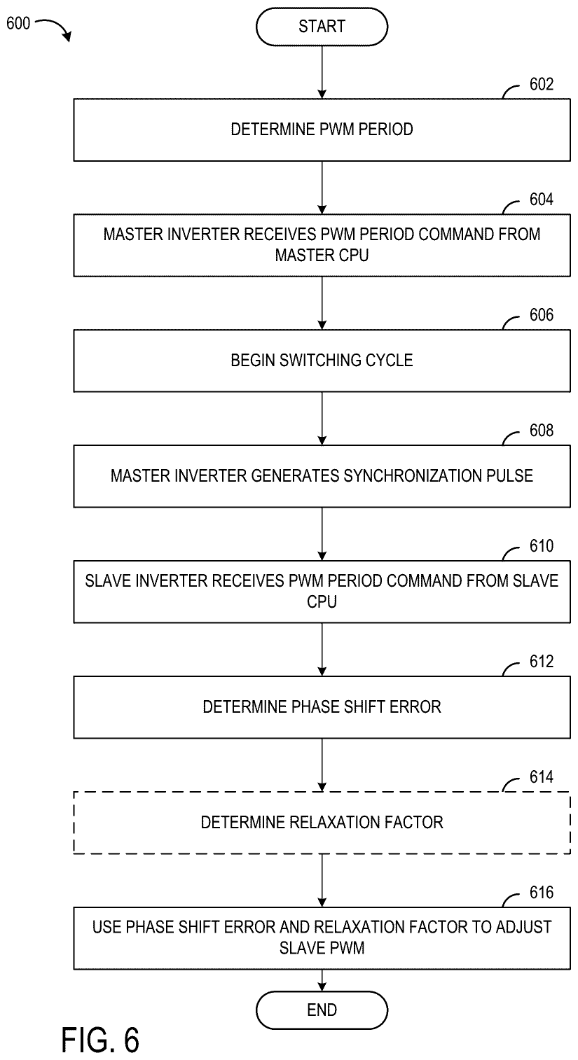

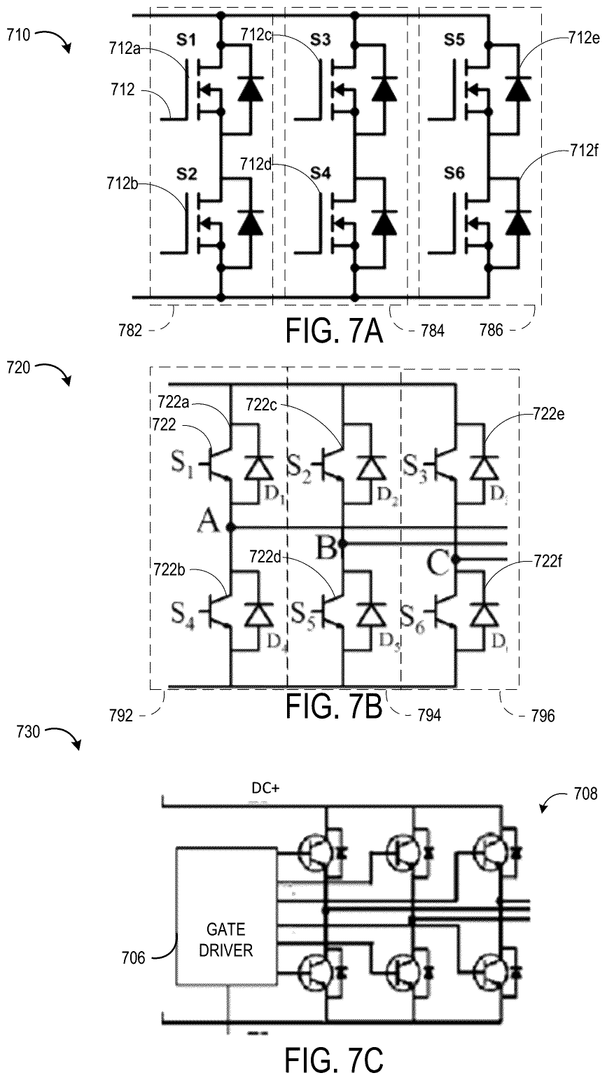

The following description relates to methods for pulse width modification (PWM) of a dual voltage inverter with dual processors and a single direct current (DC) capacitor. The dual voltage inverter may convert DC to alternating current (AC). For example, the dual voltage inverter may be incorporated into an electric vehicle (EV) (e.g., battery electric vehicle or hybrid vehicle) wherein the voltage inverter converts DC from a battery of the electric vehicle to AC that is delivered to electric machines (EMs) of the electric vehicle. An example of such an EV is shown schematically in FIG. 1. A schematic representation of an exemplary dual inverter system according to the present disclosure which may be incorporated in the electric vehicle of FIG. 1 is shown in FIG. 2. FIGS. 7A-7C show example components of power stages which may be included in the dual inverter system of FIG. 2. FIG. 6 shows an example of a method for synchronizing PWM of a dual inverter system such as the dual inverter system of FIG. 2. FIGS. 3-4 show timeline diagrams of events of interest during synchronization of a dual inverter system, such as the dual inverter system of FIG. 2. FIGS. 5A-5C show graphs of example switching cycles of the dual inverter system.

Turning to FIG. 1, a schematic drawing depicts an electric vehicle 106 with an electric drive unit (EDU) 126 that generates motive power for vehicle propulsion. The electric vehicle 106 may be a light, medium, or heavy duty vehicle. Specifically, in one use-case example, the electric vehicle 106 may be a passenger vehicle such as a truck, sedan, wagon, and the like. However, in other examples, the electric vehicle 106 may be an off-highway vehicle or other type of vehicle. Further, the electric vehicle 106 may be a battery electric vehicle (BEV), a series hybrid electric vehicle (HEV) that includes an internal combustion engine, or a fuel-cell electric vehicle, as non-limiting examples.

The EDU 126 comprises one or more electric motors 154. In some examples, the EDU 126 may comprise two electric motors 154 in a back-to-back configuration whereby the electric motors 154 are aligned coaxially and oriented facing away from each other. Electric motors 154 may be traction motors. Electric motors 154 may receive electrical power from a traction battery 158 to provide torque to rear vehicle wheels 155 and/or front vehicle wheels 156. It should be appreciated that while FIG. 1 depicts the EDU 126 and electric motors 154 mounted in a rear wheel drive configuration with drive shafts towards the rear axles, other configurations are possible, such as employing electric motors 154 in a central axle configuration, a front axle configuration, or in a configuration in which there is one or EDUs included therein, for example one EDU in a rear wheel drive configuration and a second EDU in a front wheel drive configuration.

The electric vehicle 106 may further include an inverter subsystem 102 which converts DC from the battery 158 to AC that is supplied to electric motors 154. The inverter subsystem 102 may include two or more inverters which may each include a PWM generator and a CPU. Further, the PWM frequencies may be variable according to dynamic operation conditions (e.g., speed and torque) of the electric motors 154. Electric motors 154 may also be operated as a generator to provide electrical power to charge traction battery 158, for example during a braking operation (e.g., regenerative braking).

Two, more, or all of electric motors 154 may be identical, such that each motor that is identical of electric motors 154 are the same type (e.g., induction, synchronous, etc.), and each of their parts are the same size (e.g., lengths and diameters of stators and rotors), the same weight, the same shape, the same materials, and the like. For example, the electric motors 154 may have the same number of windings, and further the windings may be the same material and have the same structure. Lamination layers of rotors and stators of electric motors 154 may be identical in shape and number. Cooling systems, if employed in electric motors 154, may be identical such that the same type and mass of coolant flows through electric motors 154, resulting in approximately the same temperatures thereof. Further, housings enclosing each of electric motors 154 may be the same size, shape, thickness, and material. Thus, electric motors 154 may rotate with similar (e.g., within a threshold range) angular speed as each other during operation of the electric vehicle 106. Further, electric motors 154 may be designed to respond similarly (e.g., identically) to an electrical signal. For example, if a first signal is sent to a first motor of electric motors 154 and causes the first motor to rotate with a first speed, the first signal being sent to a second motor of electric motors 154 may cause the second motor to rotate with approximately the first speed.

Electric motors 154 may be coupled to an outside of a transmission/gearbox housing. The transmission/gearbox housing may house a transmission system. The transmission system may include one or more shafts, gears, and clutches to transfer mechanical power generated by the electric motors 154 downstream. A controller 112 may send a signal to actuator(s) of the clutches to shift respective positions of the clutches, so as to shift gears for power transmission from the electric motors 154 to the rear vehicle wheels 155 and/or the front vehicle wheels 156.

Controller 112 may form a portion of a control system 114. Controller 112 may include a microcomputer with components such as a processor (e.g., a microprocessor unit), input/output ports, and/or an electronic storage medium for executable programs and calibration values (e.g., a read-only memory chip, random access memory, keep alive memory, a data bus, and the like). The storage medium may be programmed with computer readable data representing instructions executable by a processor for performing the methods and control techniques described herein as well as other variants that are anticipated but not specifically listed. Control system 114 is shown receiving information from a plurality of sensors 116 and sending control signals to a plurality of actuators 181. For example, the sensors 116 may include a pedal position sensor designed to detect a depression of an operator-actuated pedal such as an accelerator pedal and/or brake pedal, a speed sensor at the transmission output shaft, energy storage device state of charge (SOC) sensor, clutch position sensors, and the like. Motor speed may be ascertained from the amount of power sent from an inverter to an electric machine. An input device (e.g., accelerator pedal, brake pedal, drive mode selector, combinations thereof, and the like) may further provide input signals indicative of an intent of an operator for vehicle control, such as via actuation of the input device. As another example, the actuators may include the transmission clutches.

Upon receiving the signals from the various sensors 116 of FIG. 1, the controller 112 processes the received signals and employs various actuators 181 of vehicle components to adjust the components based on the received signals and instructions stored in the memory of controller 112. For example, the controller 112 may receive an accelerator pedal signal indicative of a request of the operator for increased vehicle acceleration. In response, the controller 112 may command operation of the inverter subsystem 102 to adjust power output of the electric motors 154, for example increase power delivered from the electric motors 154 to the transmission. The controller 112 may, during certain operating conditions, be designed to send commands to clutches to engage and disengage clutch gears. For instance, a control command may be sent to a clutch and in response to receiving the command, an actuator in the clutch may adjust the clutch based on the command for clutch engagement or disengagement. The other controllable components in the vehicle 106 may function in a similar manner with regard to sensor signals, control commands, and actuator adjustment, for example.

Turning to FIG. 2, a schematic of an exemplary dual inverter system 200 according to the present disclosure is shown. The dual inverter system 200 may include an inverter subsystem 210, a battery 212, a first EM 216, and a second EM 218. The first EM 216 and the second EM 218 may also be referred to herein as a slave EM and a master EM, respectively. The inverter subsystem 210 may include a first inverter 202, a second inverter 204, and a single DC link capacitor 214. The inverter subsystem 210 may be an example of the inverter subsystem 102 of FIG. 1, or may be included in a different system than the electric vehicle 106.

The first inverter 202 may also be referred to herein as a slave inverter, and the second inverter 204 may also be referred to herein as a master inverter. The slave inverter 202 may include a first power stage 207 communicatively coupled to a first CPU 206, respectively referred to herein as a slave power stage and a slave CPU. Likewise, the master inverter 204 may include a first power stage 209 communicatively coupled to a second CPU 208, respectively referred to herein as a master power stage and a master CPU. Further, the slave CPU 206 may include a first PWM generator 203, also referred to herein as a slave PWM generator, and the master CPU 208 may include a second PWM generator 205, also referred to herein as a master PWM generator. In some examples, the slave PWM generator 203 may be identical to the master PWM generator 205. Additionally or alternatively, the slave power stage 207 may be identical to the master power stage 209. In this way, resource demand may be minimized by reducing a number of distinct parts. In some examples, the slave inverter 202 and the master inverter 204 may not be identical due to differences between one or more of the respective power stages 207, 209, CPUs 206, 208, and PWM generators 203, 205.

For example, the inverter subsystem 210 may be the inverter subsystem 102 of FIG. 1. In the same example, a battery 212 which supplies DC to the slave inverter 202 and the master inverter 204 may be the battery 158 of FIG. 1. Further, the slave EM 216 and the master EM 218 which receive AC from the slave inverter 202 and master inverter 204, respectively, may be the electric motors 154 of FIG. 1. As such, in this example and other examples, the slave EM 216 and the master EM 218 may be identical as described above such that they may rotate with similar rotational speed during operation. The slave EM 216 and the master EM 218 may together be a dual electric machine comprising two identical EMs. Said in another way, the slave EM 216 and the master EM 218 may be identical. In other examples, the inverter subsystem 210 may deliver AC to a multiphase EM comprising more than two EMs.

In at least some examples, a housing (not shown) may enclose the inverter subsystem 210. In this way, a single housing may contain the master inverter 204 and the slave inverter 202 such that two individual housings with one for each of the master inverter 204 and the slave inverter 202 may not be demanded. Said in another way, the master inverter 204 and slave inverter 202 may be housed via a single housing (e.g., a common housing). Likewise, the electronic components of subsystems, such as computers or other controllers, specific to the master inverter 204 and slave inverter 202 may be housed by or rigidly coupled to the single housing. Thus, resource demand of the inverter subsystem 210 may be lower compared to two separate conventional inverters with two housings and two DC link capacitors.

The schematic of the dual inverter system 200 may show at least some of the current pathways between components of the dual inverter system, but does not limit circuit configurations in practice. For example, the slave inverter 202 and the master inverter 204 may be connected in series or in parallel. Additionally, the battery 212 may emit a single current that follows the pathways shown. The battery 212 may be connected in parallel with the DC link capacitor 214. Additionally or alternatively, the slave inverter 202 and/or the master inverter 204 may be connected in parallel with the DC link capacitor 214.

For example, DC current from the battery 212 may follow a first pathway 222 through the DC link capacitor 214 and to the slave inverter 202. The slave inverter 202 may convert the DC current to AC current, which may follow a second pathway 226 to the slave EM 216. DC current may also follow a third pathway 224 from the battery 212 through the DC link capacitor 214 and to the master inverter 204. The master inverter 204 may convert the DC current received into AC current which may follow a fourth pathway 228 to the master EM 218.

The slave power stage 207 may receive signals 232 from the slave CPU 206, and the master power stage 209 may receive signals 234 from the master CPU 208. Additionally, the slave CPU 206 and the master CPU 208 may be communicatively coupled via a communication bus 244. Further, to achieve synchronization, the master PWM generator 205 may produce a synchronization pulse 242 which may be received by the slave PWM generator 203, as is described further below.

Turning briefly to FIGS. 7A-7C, further details of the slave power stage 207 and the master power stage 209 of FIG. 2 are shown. The slave power stage 207 and the master power stage 209 may each include an inverter (e.g., a two level inverter or a three level inverter) and a gate driver. FIG. 7A shows a first example 710 of a two level inverter, FIG. 7B shows a second example 720 of a two level inverter, and FIG. 7C shows an example 730 of a power stage (e.g., the slave power stage 207, the master power stage 209), including a gate driver 706 and an inverter 708, wherein the inverter 708 may be a two level inverter, such as the first example 710 or the second example 720, or a three level inverter.

The first example 710 may be a two level inverter using metal-oxide-semiconductor field effect transistor (MOSFET) technology. Said in another way, some or all of a plurality of transistors 712 of the first example 710 are MOSFETs. Each of the transistors 712 includes a switch and a diode. For an example, the transistors 712 may include a first transistor 712a, a second transistor 712b, a third transistor 712c, a fourth transistor 712d, a fifth transistor 712e, and a sixth transistor 712f. The first transistor 712a and the second transistor 712b may be electrically coupled in series. The third transistor 712c and fourth transistor 712d may be electrically coupled in series. The fifth transistor 712e and the sixth 712f transistor may be electrically coupled in series. A first set of transistors enclosed by a plurality of first dashed lines 782 includes the first and second transistors 712a, 712b and may form a first series circuit. A second set of transistors enclosed by a plurality of second dashed lines 784 includes the third and fourth transistors 712c, 712d and may form a second series circuit. A third set of transistors enclosed by a third a plurality of third dashed lines 786 includes fifth and sixth transistors 712e, 712f and may form a third series circuit. The first set of transistors, the second set of transistors, and the third set of transistors may electrically couple in parallel. Said in another way, the first series circuit, the second series circuit, and the third series circuit may electrically couple together in parallel. It is to be appreciated that there may be additional sets of transistors electrically coupled in parallel besides the first set of transistors enclosed by the first dashed lines 782, the second set of transistors enclosed by the second dashed lines 784, and the third set of transistors enclosed by the third dashed lines 786.

The second example 720 may be a two level inverter using insulated-gate bipolar transistor (IGBT) technology. Said in another way, some or all of a plurality of transistors 722 of the second example 720 are IGBTs. Each of the transistors 722 includes a switch and a diode. For an example, the transistors 722 may include a first transistor 722a, a second transistor 722b, a third transistor 722c, a fourth transistor 722d, a fifth transistor 722e, and a sixth transistor 722f. The first transistor 722a and the second transistor 722b may be electrically coupled in series. The third transistor 722c and fourth transistor 722d may be electrically coupled in series. The fifth transistor 722e and the sixth transistor 722f may be electrically coupled in series. A first set of transistors enclosed by a plurality of first dashed lines 792 includes the first and second transistors 722a, 722b and may form a first series circuit. A second set of transistors enclosed by a plurality of second dashed lines 794 includes the third and fourth transistors 722c, 722d and may form a second series circuit. A third set of transistors enclosed by a third a plurality of third dashed lines 796 includes fifth and the sixth transistors 722e, 722f and may form a third series circuit. The first set of transistors, the second set of transistors, and the third set of transistors may electrically couple in parallel. Said in another way, the first series circuit, the second series circuit, and the third series circuit may electrically couple together in parallel. It is to be appreciated, that there may be additional sets of transistors electrically coupled in parallel besides the first set of transistors enclosed by the first dashed lines 792, the second set of transistors enclosed by the second dashed lines 794, and the third set of transistors enclosed by the third dashed lines 796.

Returning to FIG. 2, the master PWM generator 205 may generate a first PWM, referred to herein as a master PWM. Similarly, the slave PWM generator 203 may generate a second PWM, referred to herein as a slave PWM. Further, the master PWM may have a variable master PWM period (e.g., a duration of a switching cycle that may be different between cycles), and a master PWM frequency that is the inverse of the master PWM period. Likewise, the slave PWM may have a variable slave PWM period, and a slave PWM frequency that is the inverse of the slave PWM period.

PWM generation may be achieved in various ways, including space vector modulation and carrier-based modulation. In both aforementioned examples, a PWM period (e.g., the slave PWM period and the master PWM period) may be expressed as an integer number of CPU clock cycles and may be controlled by a clock counter, referred to herein as a PWM counter. A clock counter of a master PWM period may be referred to herein as a master PWM counter, or master counter. Similarly, a clock counter of a slave PWM period may be referred to herein as a slave PWM counter, or slave counter.

During a switching cycle (e.g., cycle including an on state and an off state of an inverter), a PWM counter (e.g., the slave PWM counter or the master PWM counter) may function as an up/down counter which increases by one with each clock cycle from zero to half the value of the corresponding PWM period (e.g., slave PWM period or master PWM period), and then returns to zero when the next PWM cycle begins by decreasing with each clock cycle for the second half of the PWM period.

The master PWM and the slave PWM may be synchronized if a same PWM period has been chosen at a time for both the slave inverter 202 and the master inverter 204. However, due to having separate CPUs, real time durations of the master PWM switching cycle and the slave PWM switching cycle may not be the same, even if a same PWM period has been chosen at a time for both PWM generators. Consequently, a phase shift of the slave PWM with respect to the master PWM may drift in time, resulting in a continuously changing phase shift between the master's DC harmonic currents and the slave's DC harmonic currents. Thus, with a fluctuating phase shift, the phase shift may be zero during some periods, therefore leading to both the master inverter 204 and the slave inverter 202 to be in the on state at the same time. In this case, harmonic current cancellation may not occur. The PWM synchronization method disclosed herein may prevent a continuously changing phase shift to optimize the DC link capacitor 214 and reduce the size thereof. To elaborate, synchronizing the slave PWM and the master PWM with a set phase shift between the slave PWM period and the master PWM period may allow for timing of on states of the slave inverter 202 and the master inverter 204 to be offset, such that the slave inverter 202 and the master inverter 204 are not in the on state at the same time. Thus, current through the DC link capacitor 214 may be decreased, compared to desynchronized systems wherein the slave inverter 202 and the master inverter 204 may have concurrent on states.

Turning to FIG. 5A, a graph 500 is shown of a master ramp 504, a synchronization pulse 506, and a slave ramp 502 with time (e.g., clock cycles) increasing to the right along the horizontal axis 512 and counts (e.g., of a slave PWM counter and a master PWM counter) increasing upwards along the vertical axis 514. The graph may represent PWMs of the master inverter 204 and the slave inverter 202, where the master ramp 504 represents a PWM of the master inverter 204, and the slave ramp 502 represents a PWM of the slave inverter 202. As described above, a count starts at 0 at the beginning of a corresponding PWM period, increase to half the PWM period, then decrease back to 0 at the end of the PWM period. Thus, three master PWM periods, or switching cycles, are shown in FIG. 5A. The desired phase shift is indicated by arrow 516, with the synchronization pulses spiking the desired phase shift after the beginning of a switching cycle 508 of the master ramp 504. Because for each of the three switching cycles shown, the slave ramp 502 increases starting at the synchronization pulse 506 of the corresponding switching cycle, the slave inverter is synchronized to the master inverter over the three switching cycles. The desired phase shift may prevent the master inverter and the slave inverter from being in on states at the same time.

Turning to FIG. 6, a method 600 is shown for synchronizing a slave PWM and a master PWM, such as the slave PWM of the slave inverter 202 and the master PWM of the master inverter 204 of FIG. 2. The method 600 may be stored at instructions in non-volatile memory of a controller, such as on a CPU of an inverter subsystem (e.g., inverter subsystem 210). The method 600 may include a single switching cycle (e.g., duration including one on state and one off state) which occurs over a single PWM period, wherein the PWM period is an inverse of PWM frequency. Further, the method 600 may be repeated for each switching cycle during a period of time (e.g., a plurality of PWM periods) in which it is desired that the master inverter and the slave inverter be synchronized.

A PWM period of a switching cycle is determined at 602 before the switching cycle starts at 606. For example, the PWM period may be determined based upon operating conditions such as speed and torque of EMs of an EV (e.g., electric motors 154 of FIG. 1) which receive AC from the inverter subsystem. In such an example, various sensors (e.g., sensors 116 of FIG. 1) may detect the operating conditions and a controller of the EV (e.g., controller 112 of FIG. 1) may send signals to a CPU of the inverter subsystem which may be used to determine the PWM period. For example, a lookup table may be stored in memory of the CPU which may include various PWM periods for certain motor speeds, torques, and combinations thereof.

The master inverter's PWM generator (e.g., master PWM generator 205 of FIG. 2) receives a PWM period command from the master's CPU (e.g., master CPU 208 of FIG. 2) at 604, wherein the PWM period command includes the determined PWM period from 602. A switching cycle begins at 606 with the switching cycle having the determined PWM period.

At 608, the master inverter, specifically the master PWM generator, generates a first pulse signal when the master PWM counter crosses a predetermined threshold. The first pulse signal may be referred to as a PWM synchronization pulse (e.g., the synchronization pulse 242), and may be received by the slave inverter's PWM generator (e.g., the slave PWM generator 203 of FIG. 2). For example, if a phase shift of ¼ of a master PWM cycle is desired between the master PWM and the slave PWM, one PWM synchronization pulse may be generated when the master PWM counter crosses (e.g., surpasses) ¼ of the master PWM period. The slave inverter's PWM generator (e.g., the slave PWM generator 203 of FIG. 2) may capture the timing of the synchronization pulse with the slave PWM counter. For example, if the PWM synchronization pulse occurs when the slave PWM counter counts a number and is rising, the slave PWM is the number of clock cycles ahead of the synchronization signal. By adding an appropriate amount of clock cycles to the next slave PWM period, a phase difference between slave PWM and the PWM synchronization signal can be reduced. As a result, the slave PWM counter may coincide with the synchronization pulse during the next switching cycle. Thus, the received synchronization pulse may be used to determine the phase shift error.

At 610, the slave CPU sends a PWM period command which is received by the PWM generator of the slave inverter. However, if PWM synchronization is demanded, the slave inverter's PWM generator may not use the PWM period command from the slave CPU directly. Instead, a calculated amount of clock cycles may be added to or subtracted from the slave PWM period command for the next slave PWM period.

At 612, a phase shift error is determined. The phase shift error may be the difference between the desired phase shift and the actual phase shift during the present switching cycle. Thus, the value of the slave PWM counter at the time when the synchronization pulse occurs is the phase shift error.

Briefly turning also to FIGS. 5B and 5C, a first graphical representation 520 and a second graphical representation 530, respectively, of unsynchronized master and slave inverters (e.g., the master inverter 204 and the slave inverter 202 of FIG. 2) are shown over a single master PWM period to illustrate examples of phase shift error. A synchronization pulse occurring when the slave counter is increasing may indicate that the start of the slave PWM period is ahead of the synchronization signal. For example, the slave ramp 502 intersects the synchronization pulse 506 as the slave ramp 502 is increasing as shown in FIG. 5B, indicating that the slave PWM period started before the synchronization pulse 506. An amount of clock cycles (e.g., phase shift error 522 or a factor thereof) may be added to the next slave PWM period in subsequent steps of the method 600. A synchronization pulse occurring when slave counter is decreasing may indicate that the slave PWM period is behind the synchronization signal. For example, the slave ramp 502 intersects the synchronization pulse 506 as the slave ramp 502 is decreasing as shown in FIG. 5C, indicating that the slave PWM period started after the synchronization pulse. An amount of clock cycles (e.g., phase shift error 524 or a factor thereof) may be subtracted from the slave PWM period in subsequent steps of the method 600. Thus, the phase shift error may be a positive value when the synchronization pulse 506 occurs in the first half of the PWM pulse (e.g., when the slave ramp 502 is increasing such as in the example of FIG. 5B), and a negative value when the synchronization pulse occurs in the second half of the PWM pulse (e.g., when the slave ramp 502 is decreasing) such as in the example of FIG. 5C. If the synchronization pulse 506 occurs exactly at the midpoint of the PWM pulse (e.g., at a peak of the slave ramp 502), the phase shift error may be either positive or negative according to preference, as either adding or subtracting the peak value may achieve the same result of synchronizing the synchronization pulse 506 with the start of the slave ramp 502 (e.g., at zero count).

Returning to FIG. 6, instead of adjusting the slave PWM period command with a number of clock cycles corresponding to a phase shift error, a relaxation factor is optionally determined at 614 and is used, in some examples, in combination with the phase shift error to calculate an adjustment in a subsequent step (616) of the method 600. The relaxation factor may be inclusively between 0 and 1, such that up to a full phase shift error may be added or subtracted to the next slave PWM period. For example, a relaxation factor of 0.5 may result in half of the phase shift error determined at 612 being added to or subtracted from the slave PWM period command. Thus, the relaxation factor may be a proportional gain factor, in some examples. The relaxation factor may be used in combination with other tuning factors to adjust the speed and accuracy of reaching the desired phase shift. A relaxation factor may be determined based upon a rate of change of the master PWM frequency and/or a desired time to synchronize the slave PWM to the master PWM. There may be a compromise between dynamic response and static ripple tolerance. Thus, the relaxation factor may depend on the application and operating conditions of electric machines, for examples. In some examples, the relaxation factor may be stored in memory of one or more of the CPUs of the inverter system such that the relaxation factor is constant. In other examples, the relaxation factor may be dynamic such that changes to the operating conditions affect the relaxation factor. The relaxation factor may be re-determined each cycle in some examples. However, in other examples, the relaxation factor may not be re-determined each cycle. Whether the relaxation factor is determined at a given switching cycle and/or a method of determining the relaxation factor may be dependent on an application of an inverter system (e.g., type of vehicle, type of EM), operating conditions within the application (e.g., speed and/or torque of EMs, current at a specific location within the inverter system) and/or factors which may depend on the operation conditions (e.g., desired phase shift, phase shift error, tolerance of phase shift error, previous relaxation factor if not constant).

At 616, the phase shift error and relaxation factor are used to adjust the slave PWM. Adjusting the slave PWM may include adjusting the slave PWM period of the slave PWM generator by increasing or decreasing by a product of the phase shift error and the relaxation factor. That is, the product of the phase shift error and the relaxation factor may be summed with the current slave PWM to produce the adjusted (e.g., next) slave PWM period. As described above, the phase shift error may be a positive or negative value. In examples where the phase shift error is negative, the adjusted slave PWM period may be shorter than the previous slave PWM period. Conversely, in examples where the phase shift error is positive, the adjusted slave PWM period may be longer than the previous slave PWM period. The magnitude of the change (e.g., increase or decrease of the slave PWM period) may depend on the absolute values of the phase shift error and the relaxation factor. For example, the larger the absolute value of the product of the phase shift error and the relaxation factor, the greater the adjustment to the slave PWM period. In other examples, the relaxation factor may not be included, and the slave PWM period may be adjusted by the phase shift error alone. By adjusting the slave PWM period after the current slave PWM period is has ended (e.g., the slave counter has reached zero), discontinuities in the control that result in instability in conventional PWM synchronizing methods when applied to variable frequency inverter systems may be prevented.

The method 600 is a non-limiting example of a method of synchronizing a dual inverter with dual CPUs and a single DC link capacitor. Variations of the method 600 may be implemented for the same purpose. For example, some steps of the method 600 may occur concurrently and/or in a different order. For instance, the slave inverter and the master inverter may receive PWM period commands from their respective CPUs at the same time, such that 610 is concurrent with 604. There may also be additional steps and/or omitted steps in some variations of the method 600. Further, the method 600, including variations thereof, may be used when synchronizing is desired, however, when synchronizing is not desired, the method 600 may be stopped. In this way, synchronization of PWMs may be enabled and disenabled as desired by respectively performing or not performing the method 600. For example, the method 600 may not be performed when a difference between frequency commands to the PWM generators is outside of a threshold difference, as discussed below with reference to FIG. 3.

Turning to FIG. 3, a timeline diagram 300 is shown for events of interest during a plurality of switching cycles wherein the PWM synchronization method of the present disclosure is employed for a dual inverter with dual CPUs and a single DC link capacitor, such as the dual inverter system 200 of FIG. 2. Time is represented along a horizontal time axis 312, where time increases from left to right (e.g., from t0 to t4). The timeline diagram 300 includes a first plot 302, a second plot 304, a third plot 306, a fourth plot 308, and a fifth plot 310. The first plot 302 shows frequency commands for a master inverter and a slave inverter wherein the frequency commands are determined from electric machine states and lookup tables (which may be stored in CPU memory as described above). The frequency commands from lookup tables for the master inverter are represented via a first trace 312 of dashed lines, and the frequency commands from lookup tables for the slave inverter are represented via a second trace 314 of dotted lines. The second plot 304 shows real (e.g., measured) frequencies after a synchronization method, such as the method 600, is employed to adjust frequency commands to the slave inverter. The real frequency for the master inverter is represented via a third trace 322 of dotted lines, and the real frequency for the slave inverter is represented via a fourth trace 324 of dashed lines. The third plot 306 shows synchronization pulses which occur at a phase shift after the start of each PWM period of the master inverter. The synchronization pulses are represented by a sharp sinusoidal solid lines of a fifth trace 332. The fourth plot 308 shows PWM pulses of the master inverter and the slave inverter, and the fifth plot 310 shows phase shifts between the PWM pulses of the fourth plot 308. The PWM pulses for the master inverter oscillate between the horizontal axis and a sixth trace 342 of dashed lines, and the PWM pulses for the slave inverter oscillate between the horizontal axis and a seventh trace 344 of dotted lines. For example, the oscillations of the PWM pulses may occur approximately as often as the synchronization pulses represented in the fourth plot 308. The phase shift is represented in the fifth plot via an eighth trace 352. When the PWM pulses arc synchronized, the phase shift may be approximately 90 degrees. In other examples, the desired phase shift may be different than 90 degrees. For example, the phase shift may be between 1 degree and 180 degrees. The phase change may be changed by a CPU of the dual inverter system.

At t1, a change in frequency command as shown in the first plot 302 and the second plot 304 disrupts synchronization which converges back to 90 degrees shortly thereafter. A similar change occurs at t2, where the frequency command decreases, causing a temporary divergence of the phase shift from 90 degrees while the PWM pulses are resynchronized to the new frequency. Between t3 and t4, the difference between the command frequencies from the slave CPU to the slave PWM generator and from the master CPU to the master PWM generator exceeds a non-zero threshold difference. That is, a difference between the traces 312 and 314, indicated by arrow 316, exceeds the threshold difference. Thus, the PWMs are not synchronized during the time interval between t3 and t4. The PWMs may not be synchronized because a synchronization method, such as the method 600 of FIG. 6, is disenabled when the threshold difference is exceeded. At 14, the difference is reduced to below the threshold; thus, the PWMs are resynchronized. The synchronization method may be re-enabled at 14. The threshold difference in frequency commands may be incorporated into memory of the CPUs of the inverter subsystem. The threshold difference may be exceeded if two electric machines to which the inverters deliver AC have substantially different rotational speeds. For example, if the slave EM 216 and the master EM 218 of FIG. 2 rotate with very different rotational speeds (e.g., greater than 5% difference in speed), the PWMs of the slave inverter 202 and master inverter 204 may not be synchronized. In this way, synchronization may be enabled and disenabled according to control systems of the CPUs. Additionally or alternatively, synchronization may be manually enabled and/or disenabled by user input as desired.

Turning to FIG. 4, a timeline diagram 400 is shown for events of interest during a plurality of switching cycles wherein the PWM synchronization method of the present disclosure is employed for a dual inverter with dual CPUs and a single DC link capacitor, such as the dual inverter system 200 of FIG. 2. The timeline diagram 400 includes a first plot 402, a second plot 404, a third plot 406, a fourth plot 408, and a fifth plot 410. The first plot 402 shows the PWM counters for two inverters. For example, the two inverters may be the slave inverter 202 and the master inverter 204 of FIG. 2 such that the first plot 402 shows counts over time for a slave PWM counter and a master PWM counter. The counts oscillate between a first trace 412 and a second trace 414. The second plot 404 shows a trace 416 indicating the state of synchronization, which may be either an enabled state or a disenabled state. The third plot 406 shows a trace 418 indicating the PWM phase shift in degrees, where the phase shift is approximately 90 degrees when the PWMs are synchronized. The fourth plot 408 shows a trace 422 indicating the PWM frequency of one of the two inverters, for example of the master PWM, which may vary between 5 KHz and 20 KHz. The fifth plot 410 shows a trace 424 indicating the PWM period, which is the inverse of the PWM frequency shown in the fourth plot 408.

The PWM frequency, and thus the PWM period, may fluctuate as shown in the fourth plot 408 and the fifth plot 410, respectively. For example, PWM frequency fluctuations may occur due to dynamic operating conditions of EMs to which the inverters deliver AC (e.g., the slave EM 216 and the master EM 218 of FIG. 2). The ability to change PWM frequency may reduce switching losses and/or reduce noise, vibration, and harshness (NVH) in a vehicle such as the vehicle 106 in FIG. 1. As described above, the counters may count up to half the corresponding PWM period. Thus, as seen in comparing the first plot 402 and the fifth plot 410, the counters change similarly to the period, but reach half the value. For example, the counters and the period reach a peak at approximately t5 and begin to decrease with approximately the same slope at around t6. The PWMs are synchronized over the time period shown in the timeline diagram 400 as the PWM phase shift is approximately 90 degrees in the third plot 406 and synchronization is enabled as shown in the second plot 404. Therefore, the traces 422 and 424 may be indicative of the frequency and period, respectively, of both the slave PWM and the master PWM.

The technical effect of the dual inverter system and method for synchronizing PWMs thereof is to allow for two inverters with separate CPUs and PWM generators with variable PWM frequencies to be synchronized with a desired phase shift therebetween. Additionally, the synchronization of the inverters may allow for reduction in size and capacity of a single shared DC link capacitor for both inverters, and therefore may reduce resource demand. Thus, the dual inverter system disclosed herein and the method for synchronizing PWMs thereof may be useful in an electric vehicle wherein PWM frequencies are changed according to the speed and torque of two electric motors, for example.

The disclosure also provides support for a method for synchronizing pulse width modulation (PWM) of a master inverter and a slave inverter, comprising: receiving a PWM command at a master PWM generator of the master inverter from a master central processing unit (CPU) communicatively coupled to the master PWM generator, generating a synchronization pulse at the master inverter, determining at a slave CPU communicatively coupled to a slave PWM generator of the slave inverter a phase shift error from the synchronization pulse, and adjusting a phase of the slave PWM generator using the determined phase shift error. In a first example of the method, a period of a master PWM cycle is determined before the PWM command is received at the master inverter. In a second example of the method, optionally including the first example, the period is not constant. In a third example of the method, optionally including one or both of the first and second examples, adjusting the phase of the slave PWM generator occurs after a slave PWM period has ended. In a fourth example of the method, optionally including one or more or each of the first through third examples, the phase shift error is a value of a counter of the slave inverter when the synchronization pulse is received. In a fifth example of the method, optionally including one or more or each of the first through fourth examples, the method further comprises: the slave inverter delivering alternating current (AC) to a first electric machine of an electric vehicle and the master inverter delivering AC to a second electric machine of the electric vehicle. In a sixth example of the method, optionally including one or more or each of the first through fifth examples, the first electric machine is identical to the second electric machine. In a seventh example of the method, optionally including one or more or each of the first through sixth examples, the method further comprises: the slave inverter and the master inverter delivering AC to a multiphase electric machine of an electric vehicle. In an eighth example of the method, optionally including one or more or each of the first through seventh examples, the method further comprises: determining a relaxation factor for the slave CPU. In a ninth example of the method, optionally including one or more or each of the first through eighth examples, adjusting the phase additionally includes using a relaxation factor with the phase shift error. In a tenth example of the method, optionally including one or more or each of the first through ninth examples, synchronizing the PWM of the master inverter and the slave inverter prevents the master inverter and the slave inverter from being in an on state at a same time. In an eleventh example of the method, optionally including one or more or each of the first through tenth examples, the synchronization pulse generates a desired phase shift after a start of a period of the master PWM generator.

The disclosure also provides support for an inverter subsystem, comprising: a master pulse width modulation (PWM) generator coupled to a direct current (DC) link capacitor, a slave PWM generator coupled to the DC link capacitor, a master CPU communicatively coupled to the master PWM generator and including instructions stored in non-volatile memory to generate a synchronization pulse received by the slave PWM generator, and a slave CPU communicatively coupled to the slave PWM generator and including instructions stored in non-volatile memory to: determine a phase shift error from the received synchronization pulse, and adjust a phase of the slave PWM generator based on the determined phase shift error. In a first example of the system, the phase of the slave PWM generator is adjusted by increasing or decreasing the phase by a product of the phase shift error and a relaxation factor. In a second example of the system, optionally including the first example the instructions of the slave CPU further including determining a relaxation factor and adjusting the phase of the slave PWM generator based on the relaxation factor.

The disclosure also provides support for a system, comprising: a battery configured to supply direct current (DC) voltage an inverter subsystem electrically coupled to the battery and configured to convert the DC current to an alternating current (AC) voltage, the inverter subsystem comprised of a master pulse width modulation (PWM) generator communicatively coupled to a master central processing unit (CPU), and a slave PWM generator communicatively coupled to a slave CPU, wherein the slave PWM generator and master PWM generator are synchronized based on a synchronization pulse generated by the master PWM generator, and a multiphase electric machine or dual electric machine configured to receive the converted AC voltage from the inverter subsystem. In a first example of the system, a frequency of a PWM cycle generated by the master PWM generator is dependent on speed and torque of the multiphase electric machine or dual electric machine. In a second example of the system, optionally including the first example, the master CPU is communicatively coupled to a master power stage comprising a two level inverter or a three level inverter and a gate driver, and wherein the slave CPU is communicatively coupled to a slave power stage comprising a gate driver and either a two level inverter or a three level inverter. In a third example of the system, optionally including one or both of the first and second examples, the inverter subsystem is enclosed by a single housing. In a fourth example of the system, optionally including one or more or each of the first through third examples, the inverter subsystem further comprises a single DC link capacitor that is electrically coupled to the slave PWM generator and the master PWM generator.

While the examples described herein use a dual motor and/or dual inverter approach, more than two motors/inverters may be used, if desired.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for synchronizing pulse width modulation (PWM) of a master inverter and a slave inverter, comprising:
receiving a PWM command at a master PWM generator of the master inverter from a master central processing unit (CPU) communicatively coupled to the master PWM generator;
generating a synchronization pulse at the master inverter;
determining at a slave CPU communicatively coupled to a slave PWM generator of the slave inverter a phase shift error from the synchronization pulse; and
adjusting a phase of the slave PWM generator using the determined phase shift error.

2. The method of claim 1, wherein a period of a master PWM cycle is determined before the PWM command is received at the master inverter.

3. The method of claim 2, wherein the period is not constant.

4. The method of claim 1, wherein adjusting the phase of the slave PWM generator occurs after a slave PWM period has ended.

5. The method of claim 1, wherein the phase shift error is a value of a counter of the slave inverter when the synchronization pulse is received.

6. The method of claim 1, further comprising the slave inverter delivering alternating current (AC) to a first electric machine of an electric vehicle and the master inverter delivering AC to a second electric machine of the electric vehicle.

7. The method of claim 6, wherein the first electric machine is identical to the second electric machine.

8. The method of claim 1, further comprising the slave inverter and the master inverter delivering AC to a multiphase electric machine of an electric vehicle.

9. The method of claim 1, further comprising determining a relaxation factor for the slave CPU.

10. The method of claim 1, wherein adjusting the phase additionally includes using a relaxation factor with the phase shift error.

11. The method of claim 1, wherein synchronizing the PWM of the master inverter and the slave inverter prevents the master inverter and the slave inverter from being in an on state at a same time.

12. The method of claim 1, wherein the synchronization pulse generates a desired phase shift after a start of a period of the master PWM generator.

13. An inverter subsystem, comprising:
a master pulse width modulation (PWM) generator coupled to a direct current (DC) link capacitor;
a slave PWM generator coupled to the DC link capacitor;
a master CPU communicatively coupled to the master PWM generator and including instructions stored in non-volatile memory to generate a synchronization pulse received by the slave PWM generator; and
a slave CPU communicatively coupled to the slave PWM generator and including instructions stored in non-volatile memory to:
determine a phase shift error from the received synchronization pulse; and
adjust a phase of the slave PWM generator based on the determined phase shift error.

14. The inverter subsystem of claim 13, wherein the phase of the slave PWM generator is adjusted by increasing or decreasing the phase by a product of the phase shift error and a relaxation factor.

15. The inverter subsystem of claim 13, the instructions of the slave CPU further including determining a relaxation factor and adjusting the phase of the slave PWM generator based on the relaxation factor.

16. A system, comprising:
a battery configured to supply direct current (DC) voltage
an inverter subsystem electrically coupled to the battery and configured to convert the DC current to an alternating current (AC) voltage, the inverter subsystem comprised of a master pulse width modulation (PWM) generator communicatively coupled to a master central processing unit (CPU), and a slave PWM generator communicatively coupled to a slave CPU, wherein the slave PWM generator and master PWM generator are synchronized based on a synchronization pulse generated by the master PWM generator; and
a multiphase electric machine or dual electric machine configured to receive the converted AC voltage from the inverter subsystem.

17. The system of claim 16, wherein a frequency of a PWM cycle generated by the master PWM generator is dependent on speed and torque of the multiphase electric machine or dual electric machine.

18. The system of claim 16, wherein the master CPU is communicatively coupled to a master power stage comprising a two level inverter or a three level inverter and a gate driver, and wherein the slave CPU is communicatively coupled to a slave power stage comprising a gate driver and either a two level inverter or a three level inverter.

19. The system of claim 16, wherein the inverter subsystem is enclosed by a single housing.

20. The system of claim 16, wherein the inverter subsystem further comprises a single DC link capacitor that is electrically coupled to the slave PWM generator and the master PWM generator.
